(19) United States
(12) Patent Application Publication
(10) Pub. No.: US 2019/0376563 A1
(43) Pub. Date: Dec. 12, 2019

(54) POWER SCREW MECHANISM WITH ROTATION CLUTCH

(71) Applicant: GE Oil & Gas UK Limited, Bristol (GB)

(72) Inventor: David John Paul HOWGATE, Bristol (GB)

(21) Appl. No.: 16/488,968

(22) PCT Filed: Feb. 27, 2018
(86) PCT No.: PCT/EP2018/054813

§ 371 Date: Aug. 27, 2019

(30) Foreign Application Priority Data
Feb. 28, 2017 (GB) 1703183.2

(51) Int. Cl. F16D 7/02; B23P 19/06

(52) U.S. Cl. CPC F16D 7/021; E21B 41/04; B23P 19/065

(57) ABSTRACT

A power screw mechanism comprising a drive screw, a main shaft, and a clutch disposed between the drive screw and the main shaft. The clutch is configured to provide a frictional engagement between the drive screw and main shaft within a first range of torques applied to the drive screw, such that rotation of the drive screw causes rotation of the main shaft over the first range of torques. The clutch is further configured to slip out of frictional engagement between the drive screw and main shaft within a second range of torques applied to the drive screw, such that rotation of the drive screw does not cause rotation of the main shaft over the first range of torques. The second range of torques is greater in magnitude than the first range of torques.

This invention relates to a power screw mechanism. The invention also relates to a remotely operated vehicle comprising a power screw mechanism, and a method of operating a power screw mechanism.

### BACKGROUND

Power screw mechanisms are commonly used in a subsea environment for operations relating to the operation of underwater hydrocarbon extraction facilities. For example, a power screw mechanism may be used by a remotely operated vehicle (ROV) for the mating of a recoverable half multiple quick connection (MQC) plate (e.g. a stabplate), for example, bearing hydraulic and electrical power and chemical injection feeds, for a subsea well to a fixed reciprocal half multiple quick connection plate (e.g. a stabplate) mounted on a subsea tree. Typically, a screw mechanism is operated by the ROV to force the two plates to mate and to lock them together. The mating and locking screw mechanism is, typically, part of the recoverable half multiple quick connection plate connection and remains subsea during the operation of the well. De-mating of the multiple quick connection plate connection for maintenance/repair purposes involves an operation by an ROV of unscrewing the screw mechanism, which is designed to force the mated plates apart.

However, during the screwing or unscrewing process, the screw mechanism may become seized causing the recoverable half multiple quick connection plate to become stuck to the fixed reciprocal half multiple quick connection plate.

The conventional way to release the recoverable half multiple quick connection plate in such a situation is to have shear pins placed within the mechanism in a cam and slot arrangement. If the mechanism becomes seized the drive screw is rotated with the now seized main shaft and the shear pins are sheared allowing the two seized items to be placed into a position where the recoverable half multiple quick connection plate can be removed.

However, the use of shear pins has a number of known drawbacks. For example, the mechanism has a tendency to shear the pins prematurely if the main shaft is not fully landed out and a torque is applied to the drives screw, since the main shaft is prevented from rotating and the applied torque is taken by the shear pins.

Additionally, when the shear pins fail they can become jammed between mating surfaces. This can make it more difficult to place the seized mechanism in the recoverable half multiple quick connection plate into a position where it can be removed.

The present invention aims to overcome the drawbacks associated with prior art drive screw mechanisms by eliminating the requirement for shear pins.

### SUMMARY OF THE INVENTION

In accordance with a first aspect of the present invention there is provided a power screw mechanism comprising: a drive screw; a main shaft; and a clutch disposed between the drive screw and the main shaft, wherein the clutch is configured to provide a frictional engagement between the drive screw and main shaft within a first range of torques applied to the drive screw, such that rotation of the drive screw causes rotation of the main shaft over the first range of torques, and the clutch is further configured to slip out of frictional engagement between the drive screw and main shaft within a second range of torques applied to the drive screw, such that rotation of the drive screw does not cause rotation of the main shaft over the second range of torques, wherein the second range of torques is greater in magnitude than the first range of torques.

The main shaft could comprise an axially extending cutout along a portion of its length, said cutout comprising first and second opposing ends. The power screw mechanism could further comprise a first rotation key within the cutout, wherein axial movement of the main shaft in a first direction is prevented when the first end of the cutout contacts the first rotation key. The power screw mechanism could further comprise a second rotation key within the cutout, wherein axial movement of the main shaft in a second direction, opposite the first direction, is prevented when the second end of the cutout contacts the second rotation key.

The main shaft could also comprise an axially and radially extending cutout along a portion of its length, said cutout comprising first and second opposing ends and clockwise and anticlockwise opposing ends. The power screw mechanism could further comprise a matched position pair of rotation keys within the cutout, wherein the axial and or radial movement of the main shaft is prevented when the respective end of the cutout contacts the pair of rotation keys.

The main shaft could comprise a tri-probe.

The clutch could circumferentially surround the drive screw.

A remotely operated vehicle could comprise a power screw mechanism as described above, as could a multiple quick connection plate, and a subsea control module.

In accordance with a second aspect of the present invention there is provided a method of operating a power screw mechanism, the power screw mechanism comprising a drive screw and a main shaft, the method comprising the steps of: providing a clutch between the drive screw and the main shaft, the clutch being configured to provide a frictional engagement between the drive screw and main shaft within a first range of torques applied to the drive screw, such that rotation of the drive screw causes rotation of the main shaft over the first range of torques, and the clutch being further configured to slip out of frictional engagement between the drive screw and main shaft within a second range of torques applied to the drive screw, such that rotation of the drive screw does not cause rotation of the main shaft over the second range of torques, the second range of torques being greater in magnitude than the first range of torques; and rotating the drive screw within one of the first and second ranges of torques.

The main shaft could comprise an axially extending cutout along a portion of its length, said cutout comprising first and second opposing ends. The power screw mechanism could further comprise a first rotation key within the cutout, wherein axial movement of the main shaft in a first direction is prevented when the first end of the cutout contacts the first rotation key. The power screw mechanism could further comprise a second rotation key within the cutout, wherein axial movement of the main shaft in a second direction, opposite the first direction, is prevented when the second end of the cutout contacts the second rotation key.

The main shaft could also comprise an axially and radially extending cutout along a portion of its length, said cutout comprising first and second opposing ends and clockwise and anticlockwise opposing ends. The power screw mechanism could further comprise a matched position pair of rotation keys within the cutout, wherein the axial and or radial movement of the main shaft is prevented when the respective end of the cutout contacts the pair of rotation keys.

The main shaft could comprise a tri-probe.

The clutch could circumferentially surround the drive screw.

The step of rotating the drive screw within one of the first and second ranges of torques could be performed by a remotely operated vehicle.

### DETAILED DESCRIPTION

The invention will now be described by way of example with reference to the accompanying drawings, in which:

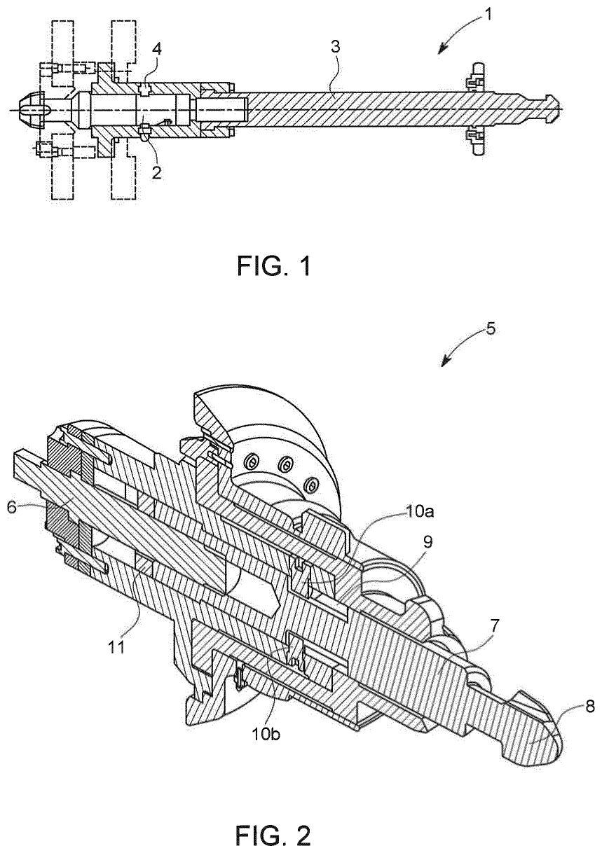

FIG. 1 schematically shows a cross-sectional view of a prior art power screw mechanism;

FIG. 2 schematically shows a perspective sectional view of a power screw mechanism according to the invention;

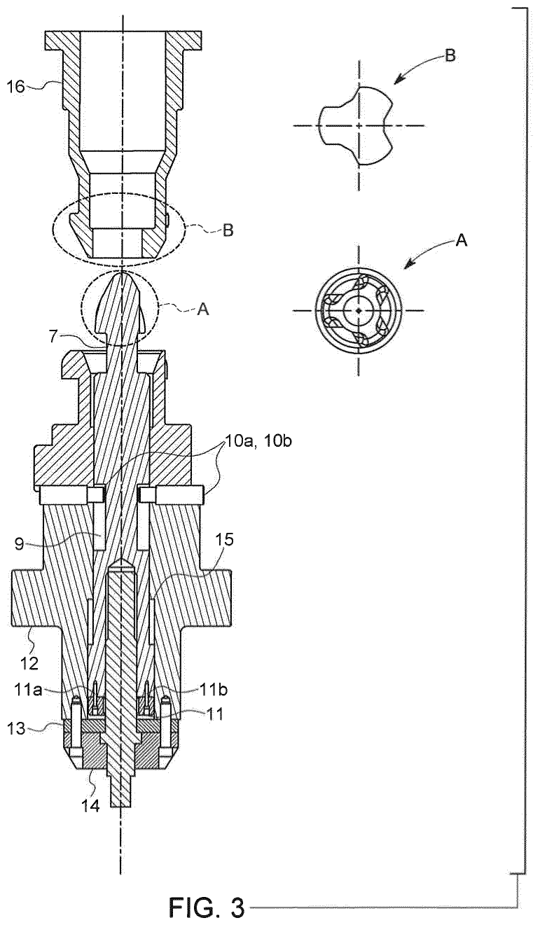

FIG. 3 schematically shows a cross-sectional view of the power screw mechanism of FIG. 2;

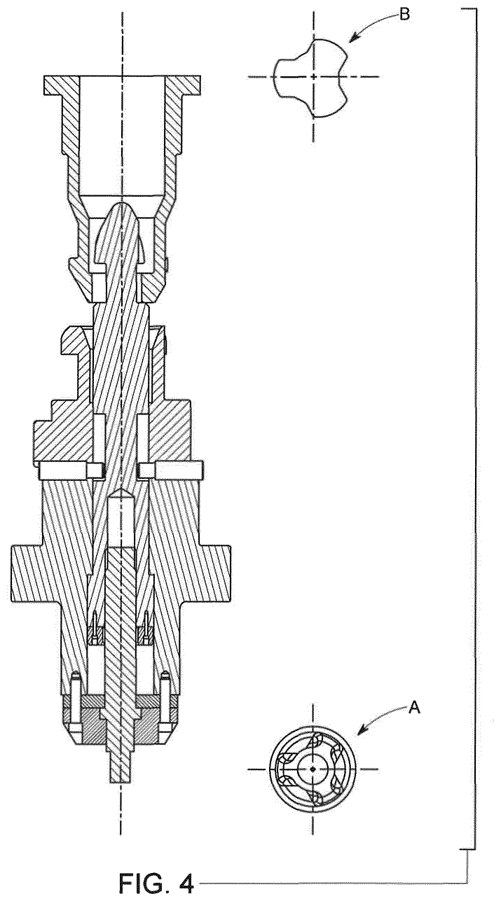

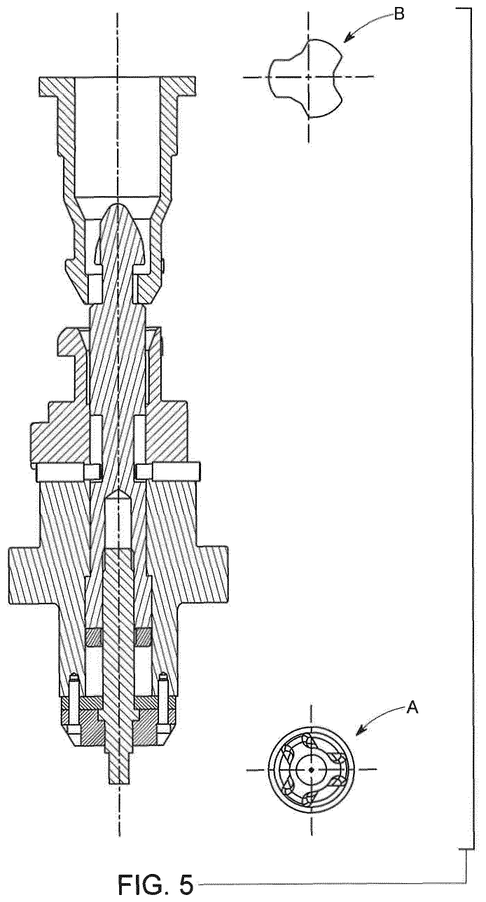

FIGS. 4 to 9 schematically show cross-sectional views of the power screw mechanism of FIGS. 2 and 3 during various stages of operation; and

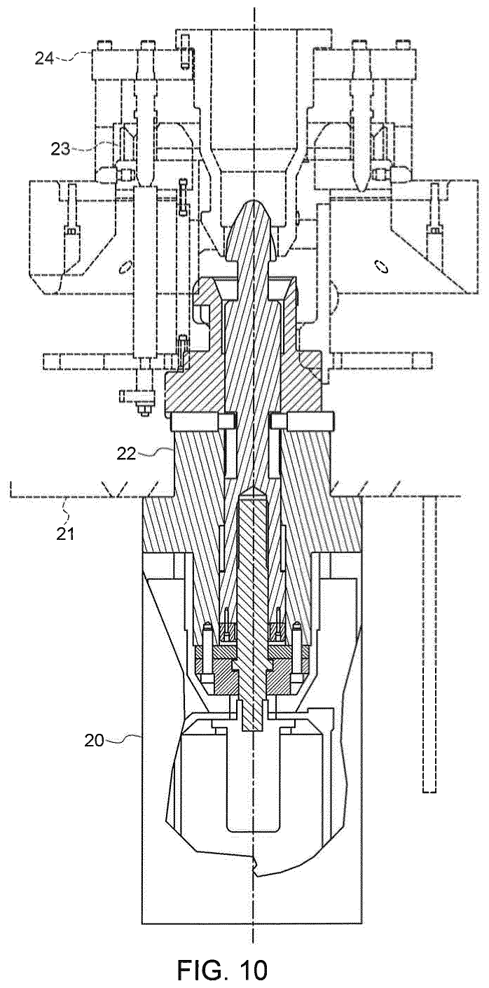

FIGS. 10 to 15 schematically show exemplary uses of the power screw mechanism of FIGS. 2 and 3.

FIG. 1 schematically shows a cross-sectional view of a prior art power screw mechanism 1. The power screw mechanism 1 comprises a main shaft 2 driven by a drive screw 3. The main shaft 2 can be extended or retracted by rotating the drive screw 3. Shear pins 4 on the main shaft 2 serve to locate the main shaft 2 at a desired location in a mating point in a subsea control module or multiple quick connection plate. If the drive screw 3 becomes seized with the main shaft 2, it is possible to apply an over torque to the drive screw 3 which will cause the orientation pins to 4 shear off.

With the shear pins 4 sheared from the main shaft 2, it is possible to disengage the seized drive screw 3 and main shaft 2. However, as described in the introduction above, the sheared shear pins 4 can become jammed between the main shaft 2 and the housing, ultimately preventing rotation of the drive screw 3 and main shaft 2 and thus separation of the mechanism.

FIG. 2 schematically shows a perspective sectional view of a power screw mechanism 5 according to the invention.

The power screw mechanism 5 comprises a drive screw 6 and a main shaft 7. The main shaft comprises a tri-probe 8, which may be used in the mating/de-mating of a multiple quick connection plate at an underwater structure in an underwater hydrocarbon extraction facility.

The main shaft 7 comprises of a pair of cutouts 9 which extend along a portion of its length. The cutout 9 has first and second opposing ends connected by first and second sidewalls. The power screw mechanism 5 further comprises a pair of rotation keys 10a, 10b. These act to limit the rotational movement of the main shaft 7 when the pair of rotation keys 10a, 10b contacts a sidewall of the cutout 9. In the embodiment of FIG. 2 the cutout 9 and rotation keys 10a, 10b have been configured to allow approximately a 60° rotation of the main shaft 7. The cutout 9 may be varied in angular extent and the rotation keys 10a, 10b positioned to allow different amounts of rotation of the main shaft 7 as required.

A clutch 11 is disposed between the drive screw 6 and the main shaft 7. The clutch 11 provides a frictional engagement between the drive screw 6 and main shaft 7 within a first range of torques applied to the drive screw 6, such that rotation of the drive screw 6 causes rotation of the main shaft 7 over the first range of torques. A typical example of a torque applied to the drive screw 6 during mating/de-mating operations is approximately 5 Nm. Therefore, the first range of torques may be, for example, approximately 0 Nm to 5 Nm.

The clutch is further configured to slip out of frictional engagement between the drive screw 6 and main shaft 7 within a second range of torques applied to the drive screw 6, such that rotation of the drive screw 6 does not cause rotation of the main shaft 7 over the second range of torques. The exact value of the second range of torques is unimportant, save that the lower end of the range should be greater than the upper end of the first range. Therefore, the second range of torques may be, for example, approximately 5.5 Nm to 500 Nm.

The clutch can be adapted to provide a frictional engagement and to slip out of frictional engagement as appropriate depending on the specific application at hand. As an alternative, the first range of torques may fall within 0.1 to 300 Nm, and the second range of the torques may fall within 0.2 to 6000 Nm.

When a torque is applied to the drive screw 6 in the second range of torques, the clutch will simply slip over the drive screw 6 and the frictional engagement between the drive screw 6 and the main shaft 7 will be lost. This will allow the main shaft 7 to be either extended or retracted if, for example, the main shaft 7 is not fully landed out or an axial load between the main shaft 7 and its mating reciprocal half prevents rotation during a mating/de-mating process. If this is the case the main shaft 7 will experience a large degree of resistance to its rotation. This in turn increases the torque on the drive screw 6, and can move the torque from a value within the first range to a value within the second range. The same process occurs when a sidewall of the cutout 9 contacts one of the rotation keys 10a, 10b.

FIG. 3 schematically shows a cross-sectional view of the power screw mechanism 5 of FIG. 2. Like reference numerals are retained as appropriate.

Further features of the power screw mechanism 5 are visible in FIG. 3. Attachment means in the form of bolts 11a and 11b connect the rotation clutch 11 to the rear of the main shaft 7. A housing 12 contains the rotation keys 10a, 10b and the main shaft 7. A thrust plate 13 is bolted to the rear end (i.e. the distal end from the tri-probe 8) of the housing 12. The thrust plate 13 is covered by and end cap 14. The housing 12 also comprises a thrust shoulder 15. The thrust shoulder acts to delimit longitudinal movement of the main shaft 7 within the housing 12.

Also shown in FIG. 3 is a portion of a fixed reciprocal half multiple quick connection plate 16. The areas indicated by A and B refer to the end of the tri-probe 8 and the jaws of the anchor point of the fixed half multiple quick connection plate 16 respectively. Views of the highlighted areas A and B viewed along the chain-dotted line (i.e. perpendicular to the cross-sectional main view) are shown at the bottom of FIG. 3. These views of areas A and B are also shown in FIGS. 4 to 9, so that the angular orientation of the tri-probe 8 can be seen at various stages of operation of the power screw mechanism 5.

In FIG. 4, the main shaft 7 of the power screw mechanism 5 is fully extended and the tri-probe 8 has been passed through the anchor point of the fixed half multiple quick connection plate 16. In the fully extended state of the main shaft 7, a portion of the main shaft contacts the thrust shoulder 15 as shown. It can be seen from the views A and B that the cross-sectional shape of the tri-probe 8 corresponds to the shape of the anchor point in this initial, disengaged orientation.

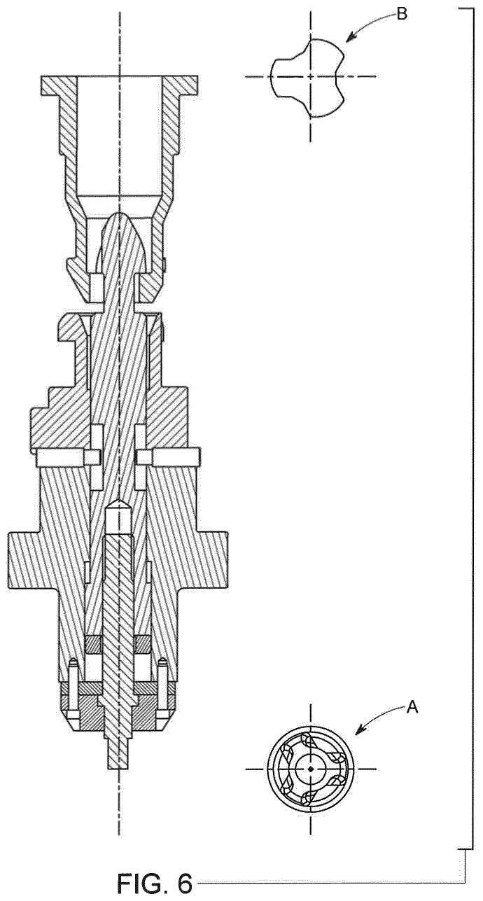

In FIG. 5, the main shaft 7 has been maintained in its extended state and the tri-probe 8 has been rotated to its engaged orientation by the drive screw 6. As the tri-probe 8 is unloaded the main shaft 7 rotates with the drive screw 6 by virtue of the frictional engagement between the drive screw 6 and the rotation clutch 11.

FIG. 6 shows the mid-point of the retraction of the main shaft 7. As can be seen from the views A and B, the tri-probe 8 remains in its engaged orientation during the retracting movement of the main shaft 7 due to the rotation keys 10a, 10b contact a sidewall of the cutout 9, thus limiting the main shafts 7 rotation. The rearward shoulder of the tri-probe 8 contacts the anchor point thus drawing the two items together during the mating process.

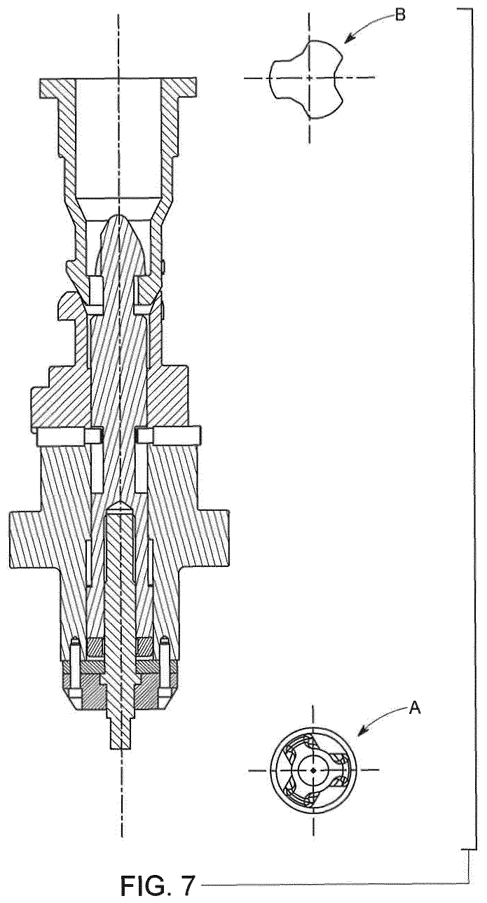

In FIG. 7, the main shaft 7 is fully retracted. The tri-probe 8 remains in its engaged orientation and the connection is mated.

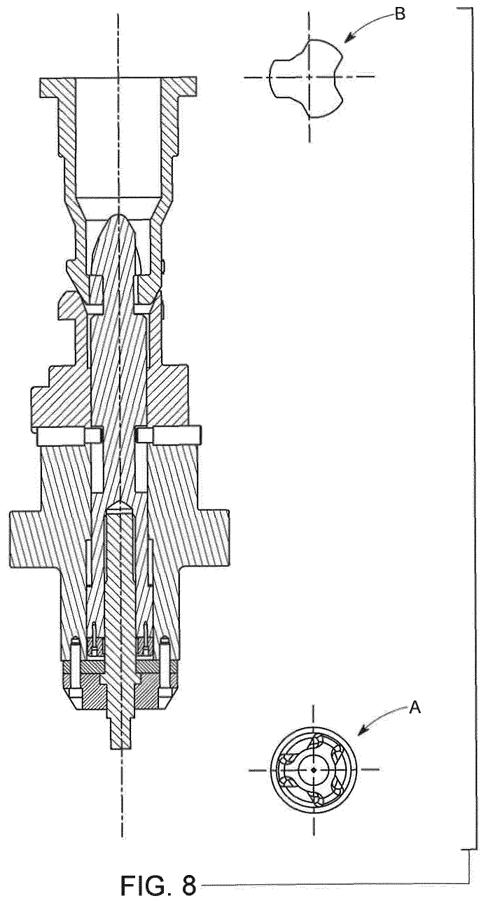

In FIG. 8, the tri-probe 8 has been rotated back to its initial disengaged orientation by rotation of the drive screw 6 in the opposite direction to the direction of rotation between FIGS. 4 and 7. This is allowed to occur when the main shaft 7 becomes unloaded during the transfer of load between the faces on the main shaft 7 with the portion of the fixed reciprocal half multiple quick connection plate, prior to driving the items apart in the de mating process, this corresponds to the first range of torques allowing the clutch 11 to provide the friction between the drive screw 6 and the main shaft 7 and thus rotating the main shaft 7. Again, the rotation keys 10a, 10b delimit the amount of angular rotation. In the disengaged orientation, the cross-sectional shape of the tri-probe 8 again corresponds to the shape of the jaws on the anchor point.

If the drive screw 6 is seized to the main shaft 7, then the main shaft 7 (and hence the tri-probe 8) will still rotate with rotation of the drive screw 6. The tri-probe can therefore be rotated to the disengaged orientation and achieve secondary release without the need for shear pins. In other words, the rotation clutch 11 does not hinder the rotation of the seized main shaft 7 and drive screw 6.

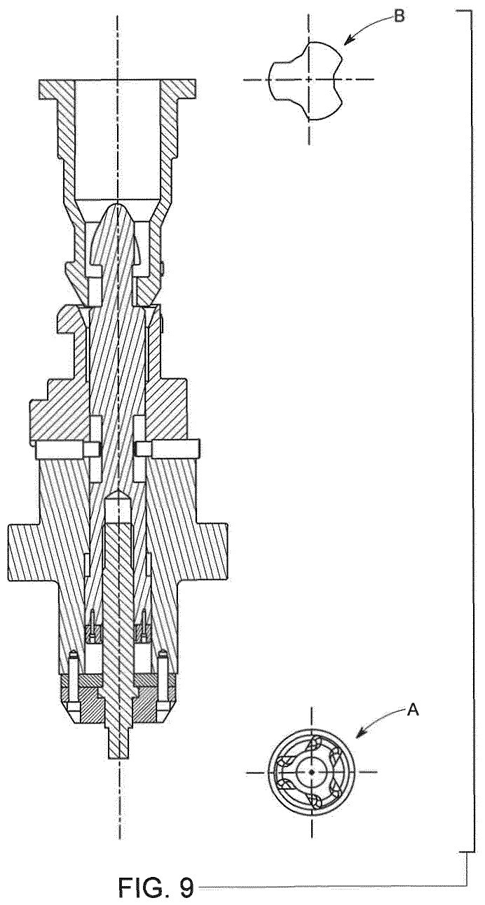

FIG. 9 shows the extension of the main shaft 7, thus driving the connection apart during the de mate process, with the tri-probe 8 in its disengaged orientation.

FIG. 10 shows a drive screw of according to the present invention incorporated into the tooling of a remotely operated vehicle (ROV).

FIG. 10 shows a tool assembly 22 incorporating a power screw mechanism as shown in FIG. 3. A drive assembly 20 has been attached to the rear of the tool assembly 22 to effect rotation of the drive screw and thus rotation, extension/retraction of the main shaft. The drive assembly 20 and tool assembly 22 are held on an ROV (not shown) via an ROV-mounted orientation tool 21, as is well known in the art.

FIG. 10 also shows an exemplary usage of the power screw mechanism. In FIG. 10, a recoverable half multiple quick connection plate 23 has been manoeuvred adjacent a fixed half multiple quick connection plate 24. Through extension, engagement, retraction and disengagement as shown in FIGS. 4 to 9, the tri-probe of the tool assembly can force the two plates against one another to mate and drive the two plates apart in the de mate process, as is well known in the art.

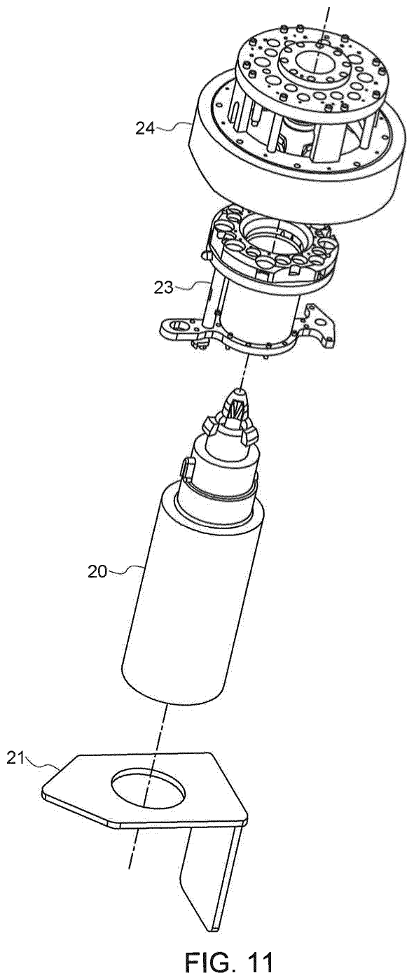

FIG. 11 shows the arrangement of FIG. 10 from a perspective view. Like reference numerals have been retained.

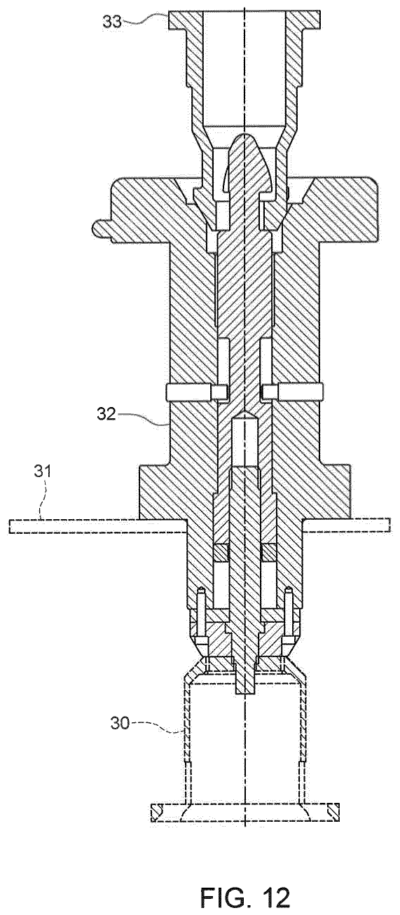

FIG. 12 shows a further exemplary usage of the power screw mechanism. In the embodiment shown in FIG. 12, the housing of the power screw mechanism has been placed with a recoverable half multiple quick connection plate 32. This enables the power screw mechanism to be fully incorporated into a releasable subsea connection, with the drive screw being operated by a standard ROV utilising current ROV interfaces known as a ‘bucket’ 30 as shown. The power screw mechanism would remain a part of the releasable connection once made up, i.e. once the recoverable half multiple quick connection plate 32 is attached to the fixed half multiple quick connection plate 33 according to the method set out in FIGS. 4 to 9. The recoverable half multiple quick connection plate 32 can have standard installation aids attached to the lifting bracket 31 as shown to help manoeuvre into place using an ROV, as is well known in the art.

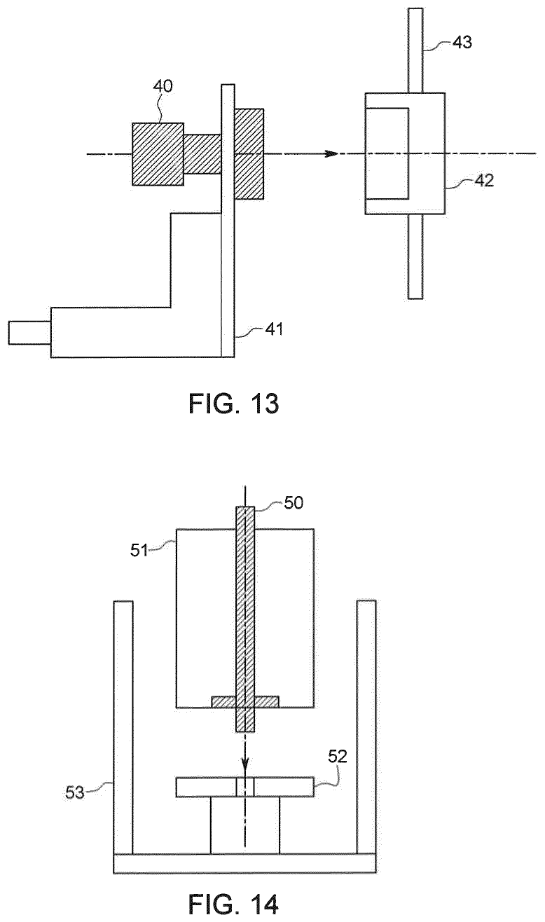

FIG. 13 shows a further exemplary usage of the power screw mechanism. In the embodiment shown in FIG. 13, a recoverable half multiple quick connection plate 40 incorporating the power screw mechanism of the present invention is incorporated one end of 41 of a flying lead assembly. The recoverable half multiple quick connection plate 40 connects to a fixed half multiple quick connection plate 42 on a subsea structure 43. Once the connection between the recoverable half multiple quick connection plate 40 and the fixed half multiple quick connection plate 42 is made up, the flying lead assembly is thereby connected to the subsea structure 43. The flying half connection 40 can either be a stand alone connection (as shown in FIGS. 2 and 3), or could be incorporated into both ends of the flying lead assembly 41. The subsea structure 43 could, for example, be a tree of a subsea well, a manifold or a distribution unit.

FIG. 14 shows a further exemplary usage of the power screw mechanism. In the embodiment shown in FIG. 14, the power screw mechanism forms part of a subsea control module connection 50. The housing of the power screw mechanism is within the subsea control module (SCM) 51, which effectively forms a recoverable half connection as it descends towards the seabed. A subsea control module mounting base 52 forms the fixed half connection and is attached to a subsea structure 53 (e.g. a tree of a subsea well, a manifold or a distribution unit). A SCM is a standard piece of equipment used in the oil and gas industry. It contains a subsea electronics module (SEM) which contains control circuitry operable to control the operation of components of a subsea well (e.g. valves, sensors, etc.).

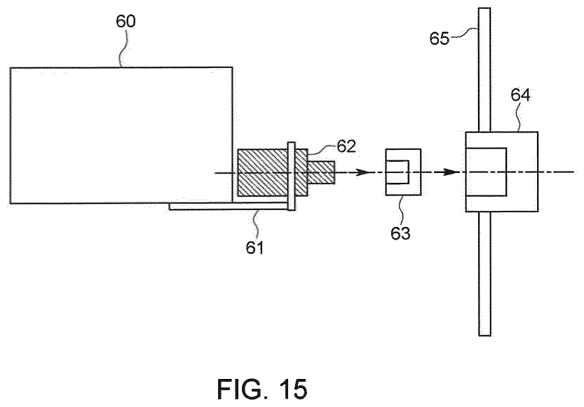

FIG. 15 shows a further exemplary usage of the power screw mechanism. In the embodiment shown in FIG. 15, a remotely operated vehicle 60 comprises an ROV-mounted orientation tool 61. A tooling system 62 incorporating a power screw according to the invention is carried in the ROV-mounted orientation tool 61. A flying half connection 63 is manoeuvred into place adjacent a fixed half connection 64 attached to a subsea structure 65. The ROV 60 pushes the tooling system 62 into engagement with the flying half connection 63 and subsequently pushes the flying half connection 63 into engagement with the fixed half connection 64 as indicated by the horizontal arrows. The attachment method is then carried out using the power screw mechanism as set out in FIGS. 4 to 9.

The invention is not limited to the specific embodiments disclosed above, and other possibilities will be apparent to those skilled in the art.

1. A power screw mechanism comprising:
a drive screw;
a main shaft; and
a clutch disposed between the drive screw and the main shaft,
wherein the clutch is configured to provide a frictional engagement between the drive screw and main shaft within a first range of torques applied to the drive screw, such that rotation of the drive screw causes rotation of the main shaft over the first range of torques, and
the clutch is further configured to slip out of frictional engagement between the drive screw and main shaft within a second range of torques applied to the drive screw, such that rotation of the drive screw does not cause rotation of the main shaft over the second range of torques,
wherein the second range of torques is greater in magnitude than the first range of torques.

2. The power screw mechanism of claim 1, wherein the main shaft comprises an axially extending cutout along a portion of its length, said cutout comprising first and second opposing ends connected by first and second sidewalls.

3. The power screw mechanism of claim 2, further comprising a first rotation key within the cutout, wherein rotational movement of the main shaft in a first direction is prevented when the first sidewall of the cutout contacts the first rotation key.

4. The power screw mechanism of claim 3, further comprising a second rotation key within the cutout, wherein rotational movement of the main shaft in a second direction, opposite the first direction, is prevented when the second sidewall of the cutout contacts the second rotation key.

5. The power screw mechanism claim 3, further comprising a matched position pair of rotation keys within the cutout, wherein rotational movement of the main shaft in either direction, is prevented when either corresponding sidewall of the cutout contacts the pair of rotation keys.

6. The power screw mechanism of claim 1, wherein the main shaft comprises a tri-probe.

7. The power screw mechanism of claim 1, wherein the clutch circumferentially surrounds the drive screw.

8. The power screw mechanism of claim 1, wherein the power screw mechanism is used in a remotely operated vehicle.

9. The power screw mechanism of claim 1, wherein the power screw mechanism is used in a multiple quick connection plate.

10. The power screw mechanism of claim 1, wherein the power screw mechanism is used in a subsea control module.

11. A method of operating a power screw mechanism, the power screw mechanism comprising a drive screw and a main shaft, the method comprising the steps of:
providing a clutch between the drive screw and the main shaft, the clutch being configured to provide a frictional engagement between the drive screw and main shaft within a first range of torques applied to the drive screw, such that rotation of the drive screw causes rotation of the main shaft over the first range of torques, and the clutch being further configured to slip out of frictional engagement between the drive screw and main shaft within a second range of torques applied to the drive screw, such that rotation of the drive screw does not cause rotation of the main shaft over the second range of torques, the second range of torques being greater in magnitude than the first range of torques; and
rotating the drive screw within one of the first and second ranges of torques.

12. The method of claim 11, wherein the main shaft comprises an axially extending cutout along a portion of its length, said cutout comprising first and second opposing ends connected by first and second sidewalls.

13. The method of claim 12, further comprising a first rotation key within the cutout, wherein rotational movement of the main shaft in a first direction is prevented when the first sidewall of the cutout contacts the first rotation key.

14. The method of claim 13, further comprising a second rotation key within the cutout, wherein rotational movement of the main shaft in a second direction, opposite the first direction, is prevented when the second sidewall of the cutout contacts the second rotation key.

15. The method of claim 12, further comprising a matched position pair of rotation keys within the cutout, wherein rotational movement of the main shaft in either direction, is prevented when either corresponding sidewall of the cutout contacts the pair of rotation keys.

16. The method of claim 11, wherein the main shaft comprises a tri-probe.

17. The method of claim 11, wherein the clutch circumferentially surrounds the drive screw.

18. The method of claim 11, wherein the step of rotating the drive screw within the first range of torques is performed by a remotely operated vehicle.

19. The method of claim 11, wherein the step of rotating the drive screw within one of the first and second ranges of torques is performed by a remotely operated vehicle.
